(19) United States
(12) Patent Application Publication
(10) Pub. No.: US 2001/0013355 A1
(43) Pub. Date: Aug. 16, 2001

(54) Fast single-article megasonic cleaning process for single-sided or dual-sided cleaning

(76) Inventor: Ahmed A. Busnaina, Norwood, MA (US)

Correspondence Address: James Marc Leas, 37 Butler Drive, S. Burlington, VT, 05403, US

(21) Appl. No.: 09/819,578

(22) Filed: Mar. 28, 2001

Related U.S. Application Data
(63) Continuation-in-part of application No. 09/655,038, filed on Sep. 5, 2000.
(63) Continuation-in-part of application No. PCT/US99/2686, filed on Aug. 2, 1999.
(60) Provisional application No. 60/104,131, filed on Oct. 14, 1998.
(60) Provisional application No. 60/192,531, filed on Mar. 28, 2000.

(51) Int. Cl. B08B 3/12

(52) U.S. Cl. 134/1.3; 134/184; 134/902

(57) ABSTRACT

A fast single-article megasonic cleaning system (200) is used to clean substrates (such as semiconductor wafers, flat panel display glass, etc.) at frequencies of 400 kHz-20,000 kHz or higher. The technique provides a single-wafer cleaning process that reduces the cleaning time from the 10-20 minutes typical of the prior art to 15-60 seconds. The system utilizes concentrated megasonic energy on one wafer (90) to dramatically reduce cleaning time. The system uses a transducer (210) or a pair or transducers (210a, 210b) parallel to the substrate (90) to be cleaned where the transducer area is more than about 40% of the substrate area. Two alternate configurations are disclosed, one utilizing a horizontal wafer arrangement and the second utilizing a vertical wafer arrangement. The latter requires a smaller floor area. Preferred spacings between the wafer and the transducer, preferred transducer power and intensity, preferred overflow flow rate of fluid medium (220) (which may be deionized water), effective cleaning times, and process temperature are disclosed.

### RELATED APPLICATIONS

This application is a continuation-in-part of patent application number Ser. No. 09/655,038, filed Sep. 5, 2000 now abandoned, which was a continuation of PCT/US99/02686/1999, filed on Aug. 2, 1999, which claims benefit of provisional application Ser. No. 60/104,131, filed Oct. 14, 1998. This application also incorporates material from provisional application Ser. No. 60/192531, filed Mar. 28, 2000.

### FIELD OF THE INVENTION

This invention relates generally to surface cleaning of articles such as semiconductor wafers, flat panel display glass, hard disk drives and heads, and the like to remove particulate and chemical contaminants. In particular, the invention relates to megasonic cleaning of oxide, metallic, or polymer films following planarization (Chemical Mechanical Polishing, CMP) and other polishing processes.

### BACKGROUND OF THE INVENTION

Wafer cleaning (especially megasonic wafer cleaning) is used before and after most basic semiconductor manufacturing processes such as: pre-oxidation, pre-CVD, pre-EPI, post-ASH, and post-CMP. Megasonic cleaning is used in every major semiconductor fabrication facility today. The majority of these processes are batch processes. A paper by G. W. Gale and A. A. Busnaina, “Removal of particle contaminations using ultrasonics and megasonics: a review”, Particulate Science and Technology, vol. 13, pp. 197-211 (1995) reviewed the background art. Some megasonic nozzles are being marketed for rinsing purposes after contact cleaning processes. Such nozzles are available from Dainippon Screen Mfg. Co. of Kyoto, Japan; Solid State Equipment Corp. of Fort Washington, Pa., and others. However, available megasonic nozzles are not sufficiently effective in cleaning wafers because of the low power, the low flow rate, and their small relative size (a small ratio of transducer area to wafer area). No effective, fast, non-contact, single-wafer cleaning process exists today. One company (Verteq, Inc., of Santa Ana, Calif.) has produced a megasonic single-wafer cleaning system called “Goldfinger.” The Goldfinger system uses one transducer above a rotating wafer, with a meniscus between the wafer and the transducer. Single-wafer megasonic cleaning methods and apparatus are described in U.S. Pat. Nos. 5,090,432, 5,148,823, and 5,286,657 to Bran.

Most megasonic cleaning tanks are employed in batch cleaning processes that may take, on average, between 10 and 20 minutes for cleaning a batch of about 25 wafers. The long cleaning time has been a major problem and a source of low production output. In addition, the majority of other semiconductor manufacturing processes are single-wafer processes. Therefore, use of a batch process for cleaning creates bottleneck and other wafer-handling problems associated with integrating the vast number of single-wafer manufacturing processes with batch cleaning processes.

Megasonic single-wafer cleaning systems using a relatively small transducer above a rotating wafer with a meniscus between the wafer and the transducer have been extensively tested by users and have not been proven sufficiently effective. Therefore they have not been generally adopted for demanding cleaning applications such as post-Chemical-Mechanical-Polishing (CMP) cleaning in the semiconductor and other industries. Reasons for the insufficient effectiveness include the facts that the megasonic energy delivered per square centimeter of the wafer is very small in such systems and that the megasonic energy is delivered for a fraction of the time during the duration of the cleaning process. These limitations diminish the cleaning effectiveness of the process.

### SUMMARY OF THE INVENTION

Accordingly, several objects and advantages of the present invention are to provide surface cleaning of semiconductor wafers, flat-panel-display glass, or hard-disk-drive disks and heads effectively in a very short time, with or without the use of chemicals other than deionized (DI) water. The process of the present invention has improved effectiveness and efficiency in comparison with all of the cleaning process products of the prior art. The cleaning system of the present invention, which is compact in size and process, puts an end to all the problems associated with batch cleaning processes. The improvements are accomplished in part by providing a new apparatus and process that utilizes a different design geometry than those commonly used in megasonic cleaning tanks. The improvements also involve system and process specifications such as the relative size of the transducer area with respect to the substrate to be cleaned (e.g., semiconductor wafers), the distance between wafer and transducer, the transducer power and intensity, the overflow flow rate, the cleaning time, and the process temperature. A particular advantage of the present invention is that maximum megasonic energy is delivered to every square centimeter of the wafer area for the entire duration of the cleaning process without the need for wafer rotation. Two alternate configurations are presented; one uses a smaller foot print to reduce the floor area that the tool will occupy. Experimental data shows that the cleaning efficiency obtained using this process (in less than one minute, and often as little as 15 seconds) is better than that of a batch megasonic cleaning after 13 minutes. A key factor is in the application of the same amount of megasonic energy to one wafer in the present invention as is used in cleaning 25 wafers in methods of the prior art. Still further objects and advantages will become apparent from a consideration of the ensuing description and accompanying drawings.

With the recent trend by semiconductor manufacturers of adopting single-wafer processes in manufacturing, the improved process of the present invention is expected to reduce cleaning and manufacturing time and is expected to solve the bottleneck and other wafer-handling problems associated with integrating the vast number of single-wafer manufacturing processes with cleaning processes.

As pointed out above, most batch cleaning megasonic cleaning processes take, on average, 10-20 minutes time for cleaning a batch of about 25 semiconductor wafers, hard-drive disks, or flat-panel-display glass substrates. Most attempts by various equipment manufacturers at cleaning a single wafer in a short time using a megasonic process have not been successful. There is an immediate need for an effective, fast, non-contact, single-wafer cleaning method especially for post-chemical-mechanical-polishing (post-CMP) cleaning applications.

### BRIEF DESCRIPTION OF THE DRAWINGS

FIG. 1. Schematic cross-sectional elevation view of a typical batch megasonic cleaning apparatus of the prior art.

FIG. 1A. Magnified detail of a portion of FIG. 1.

FIG. 2. Schematic cross-sectional elevation view of a fast single-wafer megasonic cleaning apparatus made in accordance with the present invention.

FIG. 3. Schematic cross-sectional elevation view of a second embodiment of a fast single-wafer megasonic cleaning apparatus made in accordance with the present invention.

FIG. 4. Bar chart illustrating removal efficiency of silica particles using apparatus and methods of the present invention.

FIG. 5. Bar chart illustrating removal efficiency of alumina particles using the present invention, compared with removal efficiency using a method and apparatus of the prior art for various cleaning times.

FIG. 6. Bar chart illustrating particle counts of alumina particles before and after deposition, and after cleaning by use of the present invention in comparison with particle counts with a prior art method and apparatus.

FIG. 7. Schematic cross-sectional view of a single-wafer megasonic cleaning apparatus having a pair of transducers mounted on either side of a substrate in accordance with the present invention.

FIG. 8. Schematic cross-sectional view of a horizontal embodiment of a single-wafer megasonic cleaning apparatus having a pair of transducers mounted on either side of a substrate in accordance with the present invention.

### DETAILED DESCRIPTION OF THE INVENTION

A megasonic transducer is used to clean substrates (such as semiconductor wafers) at frequencies larger than 400 kHz-20,000 kHz or higher. The technique introduces a single-wafer cleaning process that reduces the cleaning time from 10-20 minutes to the present invention's cleaning time of 15-60 seconds. The process of the present invention cleans a wafer in less than one minute without utilizing any chemistry other than deionized (DI) water. The use of chemistry such as SC1 (5-40 H₂O:1-2H₂O₂:1NH₄OH) should reduce the current cleaning time. Megasonic cleaning provides a very small acoustic boundary layer (on the order of 0.59 microns for 900 kHz) which exposes contaminants, such as submicron particles, to the fluid's acoustic stream and facilitates their removal. It has been shown that the new process is capable of completely removing particles as small as 100 nanometers (current surface detection limits). The detailed description below indicates why current megasonic equipment used today is not capable of matching the current removal efficiency provided by this invention using the same cleaning time. The semiconductor industry is quickly moving toward single-wafer processing. Today more than 80% of wafer processing is single-wafer based. This process eliminates the need for batch cleaning processes as well as reducing the time per wafer to less than 60 seconds. The cleaning time depends on the type of contaminant to be removed. For instance, silica particles can be completely removed in 15 seconds while alumina particles may need 30 seconds or more time when using DI water.

The technique is very effective when utilizing only DI water. The technique becomes even more effective when coupled with basic or acidic chemistry (depending on the substrate to be cleaned).

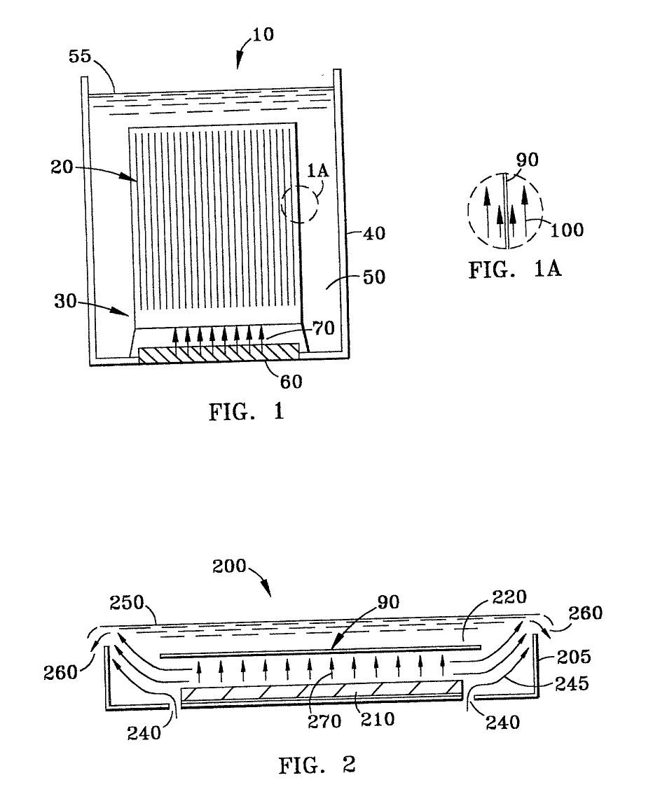

Most megasonic cleaning processes used extensively in wafer cleaning by the semiconductor, hard drive, and flat-panel display industries are batch cleaning processes that typically take between 10 and 20 minutes, on average, (for 25 wafers cleaned simultaneously in a batch cleaning tank). FIG. 1 shows a schematic cross-sectional elevation view of a typical batch megasonic cleaning apparatus 10 of the prior art. A multiplicity 20 of wafers to be cleaned is held in a cassette 30 which holds wafers 20 in a parallel arrangement inside container 40. Container 40 also holds a liquid cleaning medium 50, which has a liquid surface 55. A megasonic transducer 60 transfers megasonic energy 70 through cleaning medium 50 to the surfaces wafers 20.

FIG. 1A shows a magnified detail of a portion of FIG. 1, illustrating schematically by flow lines 100 the slower fluid flow that occurs near the surface of an individual wafer 90 in such a batch process, where the liquid medium flows between wafers. Comparisons between the results obtained using prior art apparatus similar to FIG. 1 as compared with results using the methods and apparatus of the present invention are described below. Most earlier attempts by various equipment manufacturers at cleaning a single wafer using megasonic cleaning for a short time have not been successful.

The process of the present invention is capable of accomplishing cleaning in a very short time without the use of any chemicals. This is accomplished by a new process that requires a different geometry and by controlling and using specific process specifications and parameters such as the relative size of the transducer area with respect to the substrate to be cleaned (e.g., semiconductor wafers), distance between wafer and transducer, transducer power and intensity, overflow flow rate, cleaning time, and process temperature. The process steps and the parameters controlled are presented below.

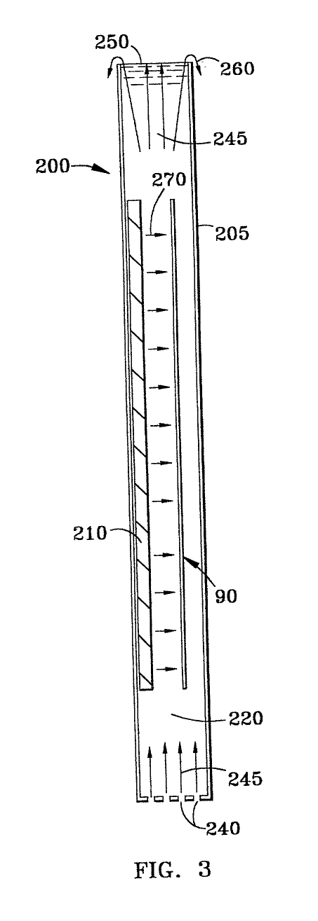

Two alternate configurations for the apparatus are presented in FIGS. 2 and 3. FIG. 2 shows a schematic cross-sectional elevation view of a first fast single-wafer megasonic cleaning apparatus 200 made in accordance with the present invention. FIG. 3 shows a schematic cross-sectional elevation view of a second embodiment of a fast single-wafer megasonic cleaning apparatus 200 made in accordance with the present invention. The second embodiment shown in FIG. 2 uses a smaller footprint to reduce the floor area the tool occupies. In both FIGS. 2 and 3, the apparatus 200 includes a container 205 for holding single wafer 90 to be cleaned and for holding the liquid cleaning medium 220, and a megasonic transducer 210 disposed to face the surface of single wafer 90 to be cleaned. Megasonic energy is directed 270 from megasonic transducer 210 toward the surface of single wafer 90 to be cleaned. The apparatus is arranged so that liquid cleaning medium 220 has a free liquid surface 250, and the liquid flow is shown in FIGS. 2 and 3 by flowlines 245 within container 205, by inlet flowlines 240, and by overflow outlet flowlines 260, showing that the liquid cleaning medium 220 overflows the container.

Megasonic transducer 210 has a transducer area between 40% and 100% of the area of the individual substrate 90 to be cleaned. The substrate 90 is positioned parallel to the transducer 210 and spaced apart from megasonic transducer 210 by a predetermined distance. A flow of liquid medium 220 is maintained between the substrate and the transducer, while applying megasonic energy at a suitable frequency of at least 400 kilohertz (kHz). Megasonic transducer 210 may be a conventional piezoelectric transducer capable of operating at a suitable frequency. A conventional supply of electrical energy at a suitable frequency is provided to drive the megasonic transducer 210. The megasonic energy applied has a maximum power of at least 400 watts. The megasonic energy applied should be between 20% and 100% of the maximum power and preferably between 50% and 100% when cleaning with DI water alone. The transducer 210 should have a total input intensity (power per unit transducer area) of at least four watts per square centimeter.

For using a transducer area of less than 100% of the area of the individual substrate 90, a relative motion between the individual substrate and the transducer is preferably provided in a direction parallel to the substrate, while performing the fluid-flowing and the megasonic-energy-applying step. The transducer should face at least 40% of the surface area of individual substrate 90 to be cleaned. That is, the major area of the transducer that faces the substrate 90 should have an area that is at least 40% of the major area of one side of the substrate 90 to be cleaned. The distance between the transducer and the individual substrate 90 should be in the range from 1% to 80% of the maximum diameter of substrate 90, or at least a minimum of 1 micrometer or larger away from the substrate. The distance between transducer 210 and the individual substrate 90 is preferably maintained in a range from 1 micrometer to 160 millimeters.

The fluid flowing in the space between the substrate and the transducer is moved at a fluid flow rate sufficient to carry particles away from the substrate before they redeposit on the substrate. The fluid medium 220 flowing in the space between substrate 90 and the transducer 210 is preferably moved at a rate suitable to replace the fluid in the cleaning container 205 in less than or equal to one minute. The overall method for megasonic cleaning of individual substrates 90 with this apparatus thus comprises the steps of: providing a megasonic transducer 210 having a transducer area between 40% and 100% of the area of the individual substrate 90 to be cleaned; disposing the individual substrate 90 substantially parallel to and spaced apart from transducer 210 by a predetermined distance, thereby defining a space between substrate 90 and transducer 210; and flowing a fluid through the space between substrate 90 and transducer 210, while applying megasonic energy to the megasonic transducer 210 at a frequency of at least 400 kilohertz (kHz). Optionally, the method can also include the further step of providing relative motion between individual substrate 90 and transducer 210 in a direction substantially parallel to substrate 90, while performing the fluid-flowing and energy-applying step. The fluid-flowing step is preferably performed at a fluid flow rate sufficient to carry particles away from the substrate before they redeposit on the substrate. Preferred process temperatures are in the range 20° C. to 70° C.

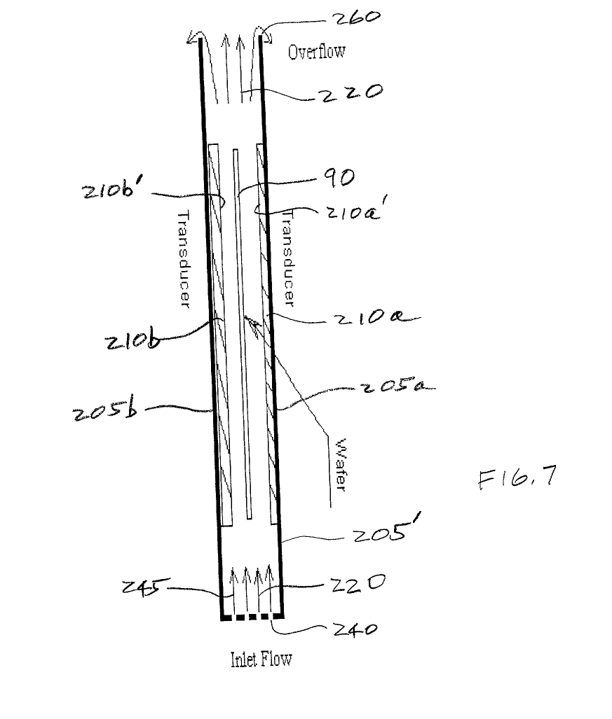

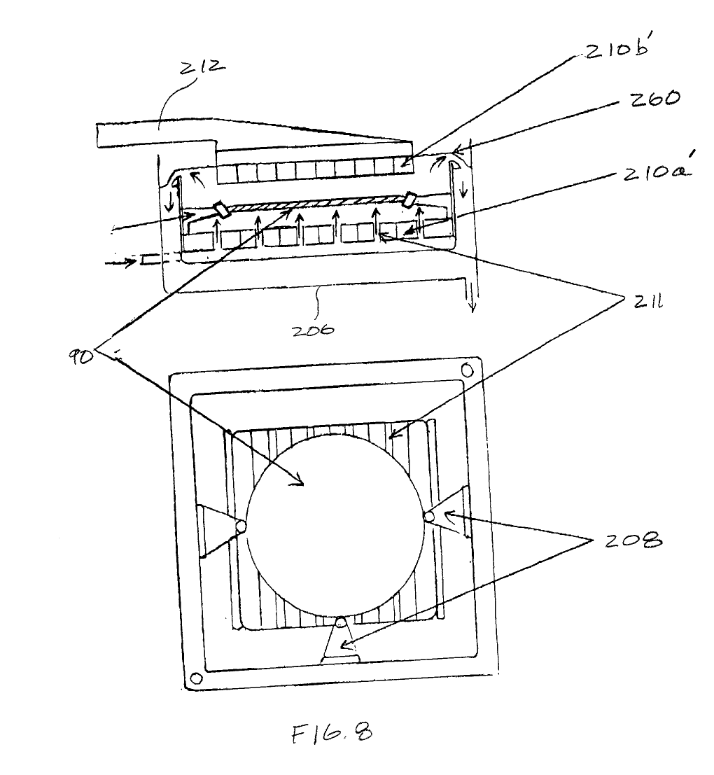

In an alternate embodiment two megasonic transducers 210a, 210b can be used to clean both sides of substrate 90, as shown for a vertical embodiment in FIG. 7. Substrate 90 is positioned parallel between transducers 210a, 210b and spaced apart from them by a predetermined distance. Both transducers 210a, 210b, or at least their active surfaces 210a′, 210b′ can be immersed in fluid 220 along with substrate 90. Transducers 210a, 210b are preferably mounted on opposite walls 205a, 205b of container 205′ in a fixed position, as shown in FIG. 7. Providing energy from both sides facilitates cleaning edges as well as both sides of substrate 90.

Fluid 220 enters container 205′ from a lower end and flows between substrate 90 and transducers 210a, 210b on each side of substrate 90 while megasonic energy is applied to transducers 210a, 210b. Preferably a frequency of at least 400 kHz is used. Fluid 220 then overflows container 205′ at the top. Other parameters of the system are similar to those provided for the single transducer embodiment described herein above.

For example if area of transducers 210a, 210b is less than the area of the substrate 90, a relative motion may be provided between substrate 90 and transducers 210a, 210b in a direction parallel to substrate 90 while performing the fluid-flowing and the megasonic energy applying step. Transducers 210a, 210b preferably each have an area at least 40% of the surface area of substrate 90.

Transducers of the size illustrated in FIGS. 2, 3, and 7, are available as an array of transducers from PCT Systems Inc. in Fremont, Calif. Individual transducers are available from Verteq Corporation in Santa Anna, California and from Imtec Corporation in Sunnyvale, Calif.

The distance between transducers 210a, 210b and substrate 90 may range from 1% to 80% of the maximum diameter of substrate 90. The distance between substrate and each transducer may be 1 micrometer or more or may range from 1 micrometer to 160 millimeters.

The megasonic energy applied can have a maximum power of 400 watts or higher. The megasonic energy applied to substrate 90 is preferably between 50% to 100% of the maximum power. Transducers 210a, 210b preferably have provide an intensity of at least four watts per square centimeter.

Fluid 220 flows in the space between substrate 90 and transducers 210a, 210b at a fluid flow rate sufficient to carry particles away before they redeposit on substrate 90. For example, the fluid flows at a rate to replace fluid 220 in cleaning container 205′ in less than or equal to one minute.

In a horizontal implementation of the invention lower array of transducers 210a′ are held in container 206, as illustrated in FIG. 8. Lower array of transducers 210a′ have openings 211 between some of the individual transducers of the array for the entrance of fluid 220 into container 206. Substrate 90 is held above transducers 210a′ with substrate holders 208. Fluid flows past both sides of substrate 90 before overflowing container 206 at overflows 260. Upper array of transducers 210b′ can be brought into position with transducer loading arm 212 once substrate 90 has been loaded on holders 208. This embodiment allows more control over spacing between substrate and transducers than the embodiment of FIG. 7. Spacing between the bottom surface of substrate 90 and lower array of transducers 210a′ is fixed by holders 208. Spacing of top surface from upper array of transducers 210b′ can be controlled by adjusting height of upper array 210b′ to accommodate differences in substrate thickness.

Experimental data show that the cleaning efficiency obtained using the present invention process (in less than one minute, as little as 15 seconds) is better than that of a batch megasonic cleaning after 13 minutes. One key factor in achieving this improvement using the present invention is in applying to one wafer the same amount of megasonic energy used in a batch process for cleaning 25 wafers.

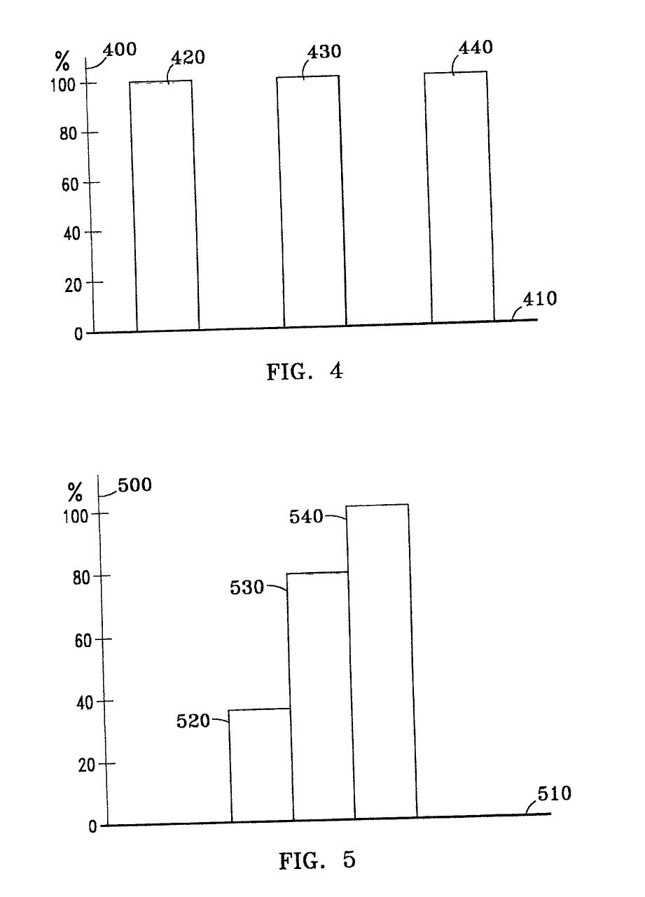

FIG. 4 is a bar chart illustrating removal efficiency of silica particles using apparatus and methods of the single transducer embodiment of the present invention. Vertical axis 400 represents particle removal efficiency, and cleaning time in seconds is plotted along horizontal axis 410. Bar 420 shows the efficiency of removing 0.15 micrometer silica particles with 15 sec. cleaning. Bar 430 shows the efficiency of removing 0.15 micrometer silica particles with 30 sec. cleaning. Bar 440 shows the efficiency of removing 0.15 micrometer silica particles with 45 sec. cleaning.

FIG. 5 is a bar chart illustrating removal efficiency of alumina particles using the single transducer embodiment of the present invention, compared with removal efficiency using a method and apparatus of the prior art for various cleaning times. In FIG. 5, vertical axis 500 represents particle removal efficiency, and the processes used are plotted along horizontal axis 510. Bar 520 depicts the efficiency of removing alumina particles with 10 min. cleaning using a batch megasonic process of the prior art. Bar 530 depicts the efficiency of removing alumina particles with 20 min. cleaning using a batch megasonic process of the prior art. Bar 540 depicts the efficiency of removing alumina particles with 1 min. cleaning using the fast single-wafer megasonic process of the present invention.

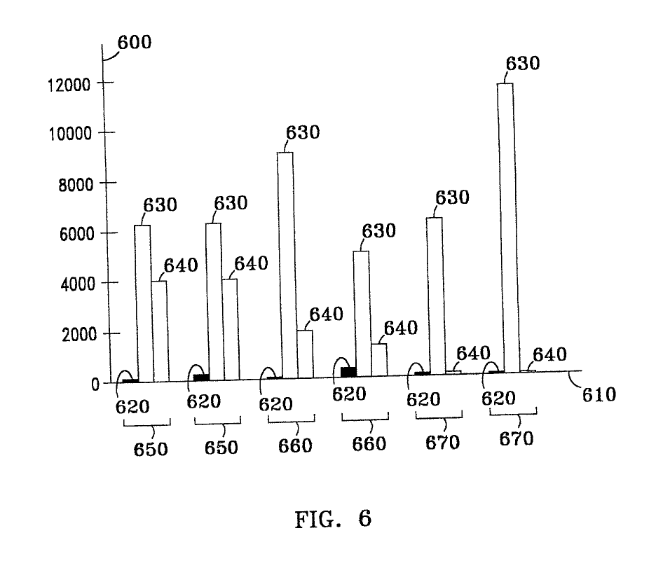

FIG. 6 is a bar chart illustrating particle counts of alumina particles before and after deposition, and after cleaning by use of the single transducer embodiment of the present invention in comparison with particle counts with a prior art method and apparatus. The number of particles larger than 0.1 micrometer is represented by vertical axis 600 of FIG. 6. The horizontal axis 610 represents the process used. Bars 620 represent the number of particles measured before deposition, bars 630 the number of particles after deposition, and bars 640 the number of particles after cleaning. Groups 650 show the results due to cleaning by a batch megasonic cleaning process of the prior art for 10 min. Groups 660 show the results due to cleaning by batch megasonic cleaning process of the prior art for 20 min. Groups 670 show the results due to cleaning by fast single-wafer cleaning process of the present invention for 1 min.

The invention provides a megasonic cleaning process capable of accomplishing cleaning of a single wafer or other substrate in a very short time without the use of any chemicals other than de-ionized water. Apparatus specially adapted for performing the single-wafer megasonic cleaning process has improved efficiency of particle removal. Apparatus made in accordance with the invention is applicable to cleaning processes that require very clean surfaces, especially semiconductor wafer and photomask cleaning processes. The methods of the invention can be used to improve cleanliness of semiconductor wafers, thus increasing the yields and lowering the costs of the semiconductor products formed on the wafers. Similar apparatus suitably arranged can be used for cleaning other planar articles, such as glass or quartz flat panel display substrates, hard-disk-drive disks, and heads.

While the invention has been shown and described in connection with a preferred embodiment, various changes may be made therein without departing from the spirit and scope of the invention as defined in the appended claims. For example, individual cleaning stations as described herein may be combined together in a cluster in arrangements other than those shown. The order of steps of the processes may, of course, be varied.

What is claimed is:

1. A method for megasonic cleaning a substrate, comprising the steps of:
a) providing a container;
b) providing a first megasonic transducer with a first active surface in said container;
c) disposing a substrate in said container substantially parallel to and spaced from said first transducer;
d) flowing a fluid through said space between the substrate and said first transducer;
e) immersing the wafer with said fluid in said container; and
f) applying energy to said first megasonic transducer.

2. A method as recited in claim 1, further comprising the step of providing relative motion between said individual substrate and said transducer in a direction substantially parallel to the substrate, while performing said fluid-flowing and energy-applying steps (d) and (f).

3. A method as recited in claim 1, wherein said individual substrate has a substrate surface area and said first active surface has an area at least equal to 40% of the substrate surface area.

4. A method as recited in claim 1, wherein the substrate has a maximum diameter and said space is in a range from 1% to 80% of said maximum diameter.

5. A method as recited in claim 1, wherein said space is in a range from 1 micrometer to 160 millimeters.

6. A method as recited in claim 1, wherein said megasonic energy applied to said megasonic transducer has a frequency of at least 400 kilohertz.

7. A method as recited in claim 1, wherein said megasonic energy applied to said megasonic transducer has a maximum power of at least 400 watts.

8. A method as recited in claim 7, wherein said megasonic energy is applied to said megasonic transducer with 20% to 100% of said maximum power.

9. A method as recited in claim 1, wherein said transducer has an area and a total input power and wherein said input power divided by said transducer area is at least four watts per square centimeter.

10. A method as recited in claim 1, wherein said flowing a fluid step (d) comprises flowing a fluid through said space between the substrate and said transducer at a fluid flow rate sufficient to carry particles away from the substrate before they redeposit on the substrate.

11. A method as recited in claim 1, wherein said container has a volume and wherein said flowing a fluid step (d) comprises flowing a fluid through said space between the substrate and said transducer at a rate to replace the fluid in said volume in less than or equal to one minute.

12. The method as recited in claim 1, further comprising the step of providing a second megasonic transducer with a second active surface in said tank, wherein said second active surface faces said first active surface, and is substantially parallel to and spaced from said first active surface.

13. The method as recited in claim 12, wherein in said providing step (b) said first transducer and said second transducer are both completely immersed in said fluid.

14. The method as recited in claim 12, wherein said disposing step (c) comprises disposing the substrate in the tank between said first active surface and said second active surface.

15. The method as recited in claim 14, wherein said flowing step (d) further comprises flowing the fluid through space between the substrate and the second active surface.

16. The method as recited in claim 15, wherein said applying energy step (f) further comprises applying energy to said second megasonic transducer.

17. The method as recited in claim 12, wherein said megasonic transducers provide energy to clean both sides and edges of the substrate.

18. The method as recited in claim 1, wherein said fluid comprises one of deonized water, dilute RCA cleaning solution and dilute citric acid solution.

19. The method as recited in claim 1, wherein in said providing step (b) said active surface is arranged in a horizontal plane.

20. The method as recited in claim 1, wherein in said providing step (b) said active surface is arranged in a vertical plane.

21. The method as recited in claim 1, wherein in said flowing step (d) fluid is provided in said tank at a lower level than it exits said tank

22. The method as recited in claim 1, wherein in said providing step (b) said first transducer is completely immersed in said fluid.

23. A method for megasonic cleaning a substrate, comprising the steps of:
a) providing a container comprising a first megasonic transducer with a first active surface, wherein said first magasonic transducer is held in a fixed position in said container;
b) disposing a substrate in said container substantially parallel to and spaced from said first active surface;
c) flowing a fluid through said space between the substrate and said first active surface; and
d) applying energy to said first megasonic transducer.

24. A method for megasonic cleaning a substrate, comprising the steps of:
a) providing a first megasonic transducer with a first active surface;
b) providing a second megasonic transducer with a second active surface facing said first active surface and parallel thereto;
c) disposing a substrate between said first surface and said second surface to provide a first space between the substrate and said first surface and a second space between the substrate and said second surface;
d) flowing a fluid through said first space and through said second space; and
e) applying energy to said first megasonic transducer and to said second megasonic transducer to clean two sides of the substrate.

25. A method as recited in claim 24, further comprising the step of providing relative motion between said individual substrate and said transducer in a direction substantially parallel to the substrate, while performing said fluid-flowing and energy-applying steps (d) and (f).

26. A method as recited in claim 24, wherein the substrate has a maximum diameter and said space is in a range from 1% to 80% of said maximum diameter.

27. A method as recited in claim 24, wherein said space is in a range from 1 micrometer to 160 millimeters.

28. A method as recited in claim 24, wherein said megasonic energy applied to said megasonic transducer has a frequency of at least 400 kilohertz.

29. A method as recited in claim 24, wherein said megasonic energy applied to said megasonic transducer has a maximum power of at least 400 watts.

30. A method as recited in claim 29, wherein said megasonic energy is applied to said megasonic transducer with 20% to 100% of said maximum power.

31. A method as recited in claim 24, wherein said transducer has an area and a total input power and wherein said input power divided by said transducer area is at least four watts per square centimeter.

32. A method as recited in claim 24, wherein said flowing a fluid step (d) comprises flowing a fluid through said first space and through said second space at a fluid flow rate sufficient to carry particles away from the substrate before they redeposit on the substrate.

33. A method as recited in claim 24, wherein said container has a volume and wherein said flowing a fluid step (d) comprises flowing a fluid through said spaces at a rate to replace the fluid in said volume in less than or equal to one minute.

34. The method as recited in claim 24, wherein in said providing step (b) said first transducer and said second transducer are both completely immersed in said fluid.

35. The method as recited in claim 24, wherein in said disposing step (c) said substrate is completely immersed in said fluid.

36. The method as recited in claim 24, wherein said megasonic transducers provide energy to clean edges of the substrate.

37. The method as recited in claim 24, wherein said fluid comprises one of deonized water, dilute RCA cleaning solution and dilute citric acid solution.

38. The method as recited in claim 24, wherein in said providing step (b) said active surface is arranged in a horizontal plane.

39. The method as recited in claim 24, wherein in said providing step (b) said active surface is arranged in a vertical plane.

40. The method as recited in claim 24, wherein in said flowing step (d) fluid is provided in said tank at a lower level than it exits said tank

41. An apparatus for megasonic cleaning a substrate, comprising:
a container for immersing a substrate in a fluid;
a first megasonic transducer with a first active surface in the fluid in said container for providing energy to clean the immersed substrate placed substantially parallel to and spaced from said first active surface.

42. An apparatus as recited in claim 41, further comprising means for providing relative motion between the substrate and said transducer in a direction substantially parallel to the substrate surface while flowing said fluid and applying said megasonic energy.

43. An apparatus as recited in claim 41, wherein the substrate has a major surface area and the substrate is disposed so that said transducer faces at least 40% of said major substrate surface area.

44. An apparatus as recited in claim 41, wherein said substrate has a maximum diameter and said space is in a range from 1% to 80% of said maximum diameter.

45. An apparatus as recited in claim 41, wherein said space is in a range from 1 micrometer to 160 millimeters.

46. An apparatus as recited in claim 41, wherein said megasonic energy applied to said megasonic transducer has a maximum power of at least 400 watts.

47. An apparatus as recited in claim 28, wherein said megasonic energy is applied to said megasonic transducer with 20% to 100% of said maximum power.

48. An apparatus as recited in claim 41, wherein said transducer has a transducer area and a total input power and wherein said input power divided by said transducer area is at least four watts per square centimeter.

49. The apparatus as recited in claim 41, further comprising a second megasonic transducer with a second active surface in said tank, wherein said second active surface faces said first active surface and is substantially parallel to and spaced from said first active surface for cleaning both sides of a substrate and edges of a substrate placed between said first active surface and said second active surface.

50. The apparatus as recited in claim 49, wherein said first transducer and said second transducer are disposed vertically.

51. The apparatus as recited in claim 49, wherein said first transducer comprises an array of transducers.

52. The apparatus as recited in claim 51, wherein said array of transducers are disposed horizontally and wherein openings between transducers permit fluid to flow there through.

53. The apparatus as recited in claim 49, wherein said first transducer is in a fixed position and said second transducer is moveable.

54. The apparatus as recited in claim 49, wherein said first transducer and said second transducer are both completely immersed in said fluid.

55. The apparatus as recited in claim 41, wherein said fluid comprises one of deonized water, dilute RCA cleaning solution and dilute citric acid solution.

56. The apparatus as recited in claim 41, wherein said first active surface is arranged in a horizontal plane.

57. The apparatus as recited in claim 41, wherein said first active surface is arranged in a vertical plane.

58. The apparatus as recited in claim 41, wherein said first transducer is completely immersed in said fluid.
